(19) United States
(12) Patent Application Publication
(10) Pub. No.: US 2024/0303776 A1
(43) Pub. Date: Sep. 12, 2024

(54) IMAGE SUPERIMPOSITION SYSTEM AND IMAGE SUPERIMPOSITION METHOD

(71) Applicant: NIPPON TELEGRAPH AND TELEPHONE CORPORATION, Tokyo (JP)

(72) Inventors: Masakazu URATA, Tokyo (JP); Satoshi SAKUMA, Tokyo (JP); Hiroshi CHIGIRA, Tokyo (JP); Tatsuya MATSUI, Tokyo (JP); Masafumi SUZUKI, Tokyo (JP); Hideaki IWAMOTO, Tokyo (JP)

(73) Assignee: NIPPON TELEGRAPH AND TELEPHONE CORPORATION, Tokyo (JP)

(21) Appl. No.: 18/574,735

(22) PCT Filed: Jun. 28, 2021
(86) PCT No.: PCT/JP2021/024421

§ 371 Date: Dec. 27, 2023

(51) Int. Cl. G06T 5/50; G06V 40/16

(52) U.S. Cl. CPC G06T 5/50; G06V 40/161; G06T 2207/20132; G06T 2207/20221

(57) ABSTRACT

An image superimposition system (100) according to the present disclosure includes: a control device (4) that generates face region image information indicating a face region image obtained by trimming a face region (R1) in a captured image, and generates superimposition object region image information indicating a superimposition object region image obtained by trimming a superimposition object region (R2) in a captured image; a face recognition device (2) that recognizes a face image and generates face image information indicating the face image; a superimposition object recognition device (3) that recognizes a superimposition image corresponding to the superimposition object region image; and a combining device (5) that detects the face image of the user from a combining region image that is an image of a combining region (R3) larger than the face region (R1) and the superimposition object region (R2) in a captured image, and generates combined image information indicating a combined image formed by superimposing the superimposition image on the face image.

### TECHNICAL FIELD

The present disclosure relates to an image superimposition system and an image superimposition method.

### BACKGROUND ART

There is a conventionally known technique for separating an image of an object (a foreground image in which the object is captured) from a background in an image in which a subject is captured by a camera (Patent Literature 1).

Also, a technique of augmented reality (AR) superimposition by which another image is superimposed and displayed on an image obtained by imaging a subject by a camera has been known, and a service called “Henshin Kabuki” using the AR superimposition technique has been suggested (Non Patent Literatures 1 and 2).

A combining device that is used in the service of “Henshin Kabuki” obtains a face image from an image obtained by imaging a user, and recognizes the type of “kumadori”, which is the makeup method for exaggerating facial expressions, from an image obtained by imaging a mask to which “kumadori” makeup is applied. The image combining device then superimposes the “kumadori” image indicating the “kumadori” makeup recognized in the preparation stage on the face image in the image obtained by imaging the user, and displays the resultant image. At this point of time, the image combining device causes the “kumadori” makeup image to follow (track) the movement of the position of the face image in the image.

When the face image changes with a change in the facial expression of the person being captured by the camera, the image combining device can also change the shape of the “kumadori” makeup image to be superimposed, on the basis of the change. For example, when the person opens the mouth, the combining device changes the shape of the “kumadori” makeup image so that the portion corresponding to the mouth opens. Further, when the person switches the posture from facing to the front to facing to the left with respect to the camera, and shows the right cheek to the camera, for example, the combining device superimposes the “kumadori” makeup image as observed from the right cheek side.

In this manner, the image combining device displays the face of the user of the service as if “kumadori” makeup were applied to the face of the user. Thus, the user can easily experience “kumadori” makeup, without actually applying the “kumadori” makeup to his/her own face.

### CITATION LIST

### Patent Literature

Patent Literature 1: JP 2020-17136 A

### Non Patent Literature

Non Patent Literature 1: Usui and three others, “Collaboration of Kabuki and ICT”, NTT Technical Journal, November 2018, page 26, [online], [searched on Jun. 10, 2021], the Internet <URL: https://journal.ntt.co.jp/article/3992>
Non Patent Literature 2: “Interactive exhibition, “Henshin Kabushiki”, which was well received in Las Vegas, USA, will be released in Japan—First-time appearance in Japan at Tokyo Edoweek—a news release from NTT”, [online], [searched on Jun. 10, 2021], the Internet <URL: https://group.ntt/jp/newsrelease/2016/09/20/160920a.html>

### SUMMARY OF INVENTION

### Technical Problem

By the conventional techniques mentioned above, in a captured image, the region where the combining device performs the process to recognize the face image, the region where the combining device perform the process to recognize the type of “kumadori” makeup, and the region where the face image is recognized to form a superimposition image are the same. Therefore, if these regions are made larger, the accuracy of recognition of the face image and the type of “kumadori” makeup becomes lower. If these regions are made smaller, the face image moves out of the region when the user changes the position of the face. Therefore, a superimposition image cannot be superimposed on the face image.

The present disclosure is made in view of such circumstances, and aims to provide an image superimposition system and an image superimposition method for enabling superimposition of a superimposition image on a face image even when the user changes the position of the face, while improving the accuracy of recognition of the face image and the type of makeup.

### Solution to Problem

To solve the above problem, an image superimposition system according to the present disclosure includes: a control device that generates face region image information indicating a face region image obtained by trimming a face region in a captured image obtained by an imaging device imaging a user in a first stage, and generates superimposition object region image information indicating a superimposition object region image obtained by trimming a superimposition object region in a captured image obtained by the imaging device imaging a superimposition object in the first stage; a face recognition device that recognizes a face image of the user included in the face region image, and generates face image information indicating the face image; a superimposition object recognition device that recognizes a superimposition image corresponding to the superimposition object region image; and a combining device that detects a face image of the user on the basis of the face image information from a combining region image that is an image of a combining region larger than the face region and the superimposition object region in a captured image obtained by the imaging device imaging the user in a second stage after the first stage, and generates combined image information indicating a combined image formed by superimposing the superimposition image on the face image.

Also, to solve the above problem, an image superimposition method according to the present disclosure includes: a step of generating face region image information indicating a face region image obtained by trimming a face region in a captured image obtained by an imaging device imaging a user in a first stage; a step of generating superimposition object region image information indicating a superimposition object region image obtained by trimming a superimposition object region in a captured image obtained by the imaging device imaging a superimposition object in the first stage; a step of recognizing a face image of the user included in the face region image, and generating face image information indicating the face image; a step of recognizing a superimposition image corresponding to the superimposition object region image; a step of detecting a face image of the user on the basis of the face image information from a combining region image that is an image of a combining region larger than the face region and the superimposition object region in a captured image obtained by the imaging device imaging the user in a second stage after the first stage; and a step of generating combined image information indicating a combined image formed by superimposing the superimposition image on the face image.

### Advantageous Effects of Invention

With an image superimposition system and an image superimposition method according to the present disclosure, a superimposition image can be superimposed on a face image even if the user changes the position of the face, while the accuracy of recognition of the face image and the type of makeup is improved.

### BRIEF DESCRIPTION OF DRAWINGS

FIG. 1 is a schematic diagram of an image superimposition system according to a first embodiment.

FIG. 2A is a diagram illustrating a face region in a captured image.

FIG. 2B is a diagram illustrating a superimposition object region in a captured image.

FIG. 3A is a diagram illustrating another example of the mask illustrated in FIG. 2B.

FIG. 3B is a diagram illustrating yet another example of the mask illustrated in FIG. 2B.

FIG. 4 is a table showing an example of information stored in a region information storage unit illustrated in FIG. 1.

FIG. 5 is a diagram illustrating a combining region in a captured image.

FIG. 6A is a sequence diagram showing part of an example operation in the image superimposition system illustrated in FIG. 1.

FIG. 6B is a sequence diagram showing the remaining part of an example operation in the image superimposition system illustrated in FIG. 1.

FIG. 7 is a schematic diagram of an image superimposition system according to a second embodiment.

FIG. 8A is a sequence diagram showing part of an example operation in the image superimposition system illustrated in FIG. 7.

FIG. 8B is a sequence diagram showing the remaining part of an example operation in the image superimposition system illustrated in FIG. 7.

FIG. 9 is a hardware block diagram of a control device and a combining device.

### DESCRIPTION OF EMBODIMENTS

### First Embodiment

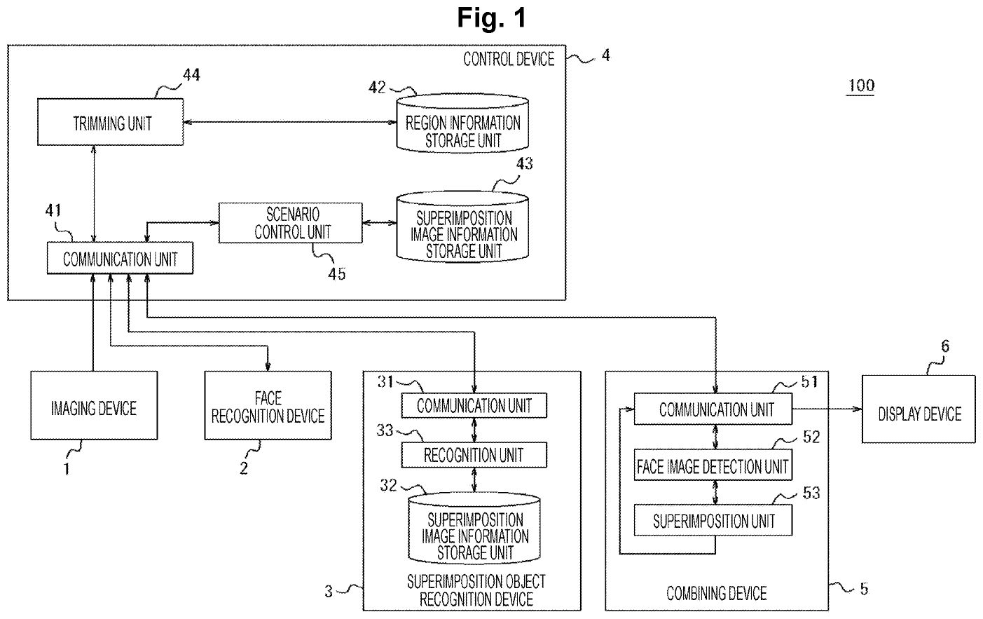

An overall configuration of a first embodiment is now described with reference to FIG. 1. FIG. 1 is a schematic diagram of an image superimposition system 100 according to this embodiment.

As illustrated in FIG. 1, the image superimposition system 100 according to the first embodiment includes an imaging device 1, a face recognition device 2, a superimposition object recognition device 3, a control device 4, a combining device 5, and a display device 6. The control device 4 communicates with the imaging device 1, the face recognition device 2, the superimposition object recognition device 3, and the combining device 5 via a communication network. The combining device 5 communicates with the display device 6 via a communication network.

### <Configuration of the Imaging Device>

The imaging device 1 is formed with a camera including an optical element, an imaging element, a communication interface, and the like. For the communication interface, the standard for Ethernet (registered trademark), fiber distributed data interface (FDDI), or Wi-Fi (registered trademark) may be used.

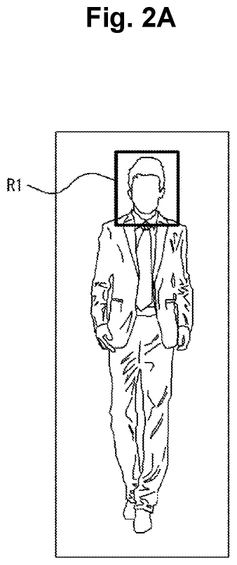

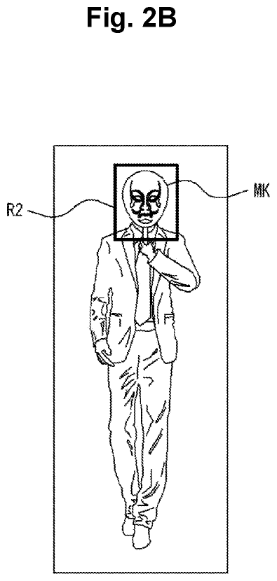

In the preparation stage (first stage), the imaging device 1 generates captured image information indicating a captured image obtained by capturing an image of the user of the image superimposition system 100 as illustrated in FIG. 2A. The captured image herein may be a still image. At this stage, a mechanism for adjusting the position of the user's face in the real space may be provided so that the face image is included in a face region R1 that will be described later in detail. Specifically, the imaging device 1 images at least a part of the user including the face of the user. At least a part of the user may be the upper body of the user including the face of the user. Alternatively, at least a part of the user may be the entire body of the user including the face of the user.

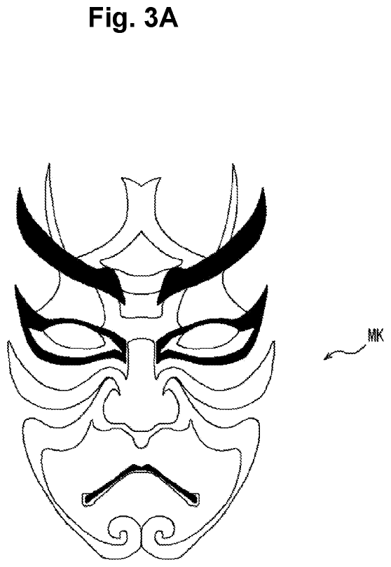

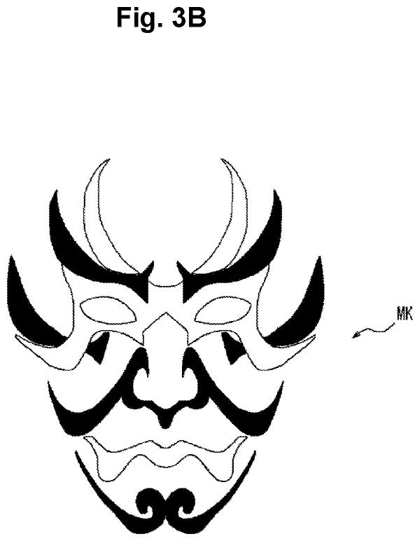

In the preparation stage, the imaging device 1 also generates captured image information indicating a captured image obtained by capturing a superimposition object disposed in a predetermined region. The predetermined region may be a region between the face and the imaging device, for example. The captured image herein may also be a still image. For example, as illustrated in FIG. 2B, the imaging device 1 may generate captured image information indicating a captured image obtained by capturing a superimposition object together with the user, with the superimposition object being located between the face of the user and the imaging device 1. At this stage, a mechanism for adjusting the position of the superimposition object in the real space may be provided so that the image of the superimposition object is included in a superimposition object region R2 that will be described later in detail. The superimposition object is an object that exists in the real space and corresponds to the image the combining device 5 is to superimpose on the image of the user's face captured by the imaging device 1. In an example illustrated in FIG. 2B, the superimposition object is a mask MK to which “kumadori” makeup for exaggerating facial expressions is applied as in Kabuki. The mask MK does not necessarily look like the example illustrated in FIG. 2B, but it may be one of the masks MK illustrated in FIGS. 3A and 3B, or may be any other mask MK.

In the service providing stage (second stage) after the preparation stage, the imaging device 1 also generates captured image information indicating a captured image obtained by capturing an image of the user. The captured image herein may be a moving image. In the service providing stage, the user imaged by the imaging device 1 is the user imaged by the imaging device 1 in the preparation stage.

Further, the imaging device 1 transmits the captured image information to the control device 4 via the communication network.

### <Configuration of the Face Recognition Device>

The face recognition device 2 illustrated in FIG. 1 is formed with a computer that includes a control unit (controller), a communication interface, and the like. The control unit may be formed with dedicated hardware such as an application specific integrated circuit (ASIC) or a field-programmable gate array (FPGA), may be formed with a processor, or may be designed to include both dedicated hardware and a processor.

The face recognition device 2 receives face region image information transmitted from the control device 4, and the face region image information will be described later in detail. The face recognition device 2 then recognizes the user's face image included in the face region image indicated by the face region image information, and generates face image information indicating the face image. The method by which the face recognition device 2 recognizes the face image may be any appropriate method. The face recognition device 2 also transmits the face image information to the control device 4.

### <Configuration of the Superimposition Object Recognition Device>

As illustrated in FIG. 1, the superimposition object recognition device 3 includes a communication unit 31, a superimposition image information storage unit 32, and a recognition unit 33. The communication unit 31 is formed with a communication interface that transmits and receives information to and from the outside. The superimposition image information storage unit 32 is formed with a memory such as a hard disk drive (HDD), a solid-state drive (SSD), an electrically erasable programmable read-only memory (EEPROM), a read-only memory (ROM), or a random access memory (RAM). The recognition unit 33 forms a control unit.

The communication unit 31 receives superimposition object region image information transmitted from the control device 4, and the superimposition object region image information will be described later in detail. The communication unit 13 also transmits a superimposition image identification (ID) (superimposition image identifier) to the control device 4, and the superimposition image ID will be described later in detail.

The superimposition image information storage unit 32 stores a superimposition image and a superimposition image ID that are associated with each other. The superimposition image is the image to be superimposed on a captured image obtained by the imaging device 1 imaging the user in the service providing stage. The superimposition image ID is an identifier for identifying the superimposition image. As described above, in an example in which the superimposition object is the mask MK to which “kumadori” makeup is applied as in Kabuki, the superimposition image is an image of the makeup portion on the mask MK to which the “kumadori” makeup is applied.

The recognition unit 33 recognizes the superimposition image corresponding to the superimposition object region image indicated by the superimposition object region image information. At this point of time, the recognition unit 33 may recognize the superimposition image corresponding to the superimposition object region image indicated by the superimposition object region image information, from among the superimposition images stored in the superimposition image information storage unit 32. The recognition unit 33 then extracts the superimposition image ID that corresponds to the recognized superimposition image and is stored in the superimposition image information storage unit 32. The recognition unit 33 also controls the communication unit 31 to transmit the superimposition image ID to the control device 4.

### <Configuration of the Control Device>

The control device 4 includes a communication unit 41, a region information storage unit 42, a superimposition image information storage unit 43, a trimming unit 44, and a scenario control unit 45. The communication unit 41 is formed with a communication interface. The region information storage unit 42 and the superimposition image information storage unit 43 are formed with memories. The trimming unit 44 and the scenario control unit 45 constitute a control unit.

The communication unit 41 receives the captured image information from the imaging device 1. The communication unit 41 also receives the face image information from the face recognition device 2. The communication unit 41 further receives the superimposition image ID from the superimposition object recognition device 3. The communication unit 41 also transmits information to the combining device 5, under the control of the scenario control unit 45.

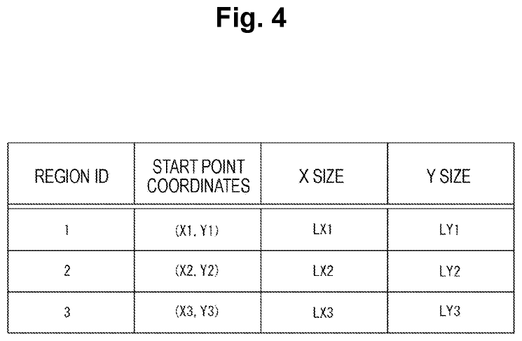

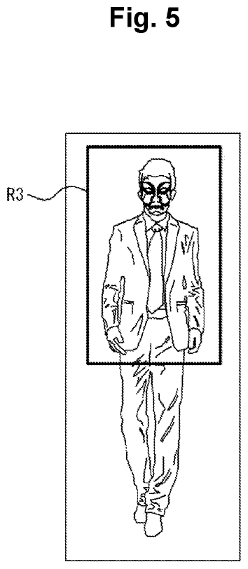

As illustrated in FIG. 4, the region information storage unit 42 stores region IDs (region identifiers) for identifying the regions in the captured image, and information indicating the ranges of the regions, the region IDs being associated with the information. The regions include the face region R1, the superimposition object region R2, and a combining region R3, and each region is a predetermined region. As illustrated in FIG. 2A, the face region R1 is a region in the captured image of the user captured in the preparation stage, and is the region expected to include the face image of the user. As illustrated in FIG. 2B, the superimposition object region R2 is a region in the captured image of the superimposition object captured in the preparation stage, and is the region expected to include the image of the superimposition object. As illustrated in FIG. 5, the combining region R3 is a region in the captured image of the user captured in the service providing stage, and is the region expected to include the face image even if the user moves the position of the face. The combining region R3 is larger than the face region R1 and the superimposition object region R2. The combining region R3 can be a region including a whole-body image showing the entire body of the user, for example.

In the example illustrated in FIG. 4, the information indicating the ranges of regions includes start point coordinates, X sizes, and Y sizes. Specifically, the face region R1 is the region surrounded by a rectangle that is identified by a region ID “1”, has a length LX1 in the X-axis direction from start point coordinates (X1, Y1), and has a length LY1 in the Y-axis direction. Meanwhile, the superimposition object region R2 is the region surrounded by a rectangle that is identified by a region ID “2”, has a length LX2 in the X-axis direction from start point coordinates (X2, Y2), and has a length LY2 in the Y-axis direction. The combining region R3 is the region surrounded by a rectangle that is identified by a region ID “3”, has a length LX3 in the X-axis direction from start point coordinates (X3, Y3), and has a length LY3 in the Y-axis direction.

Like the superimposition image information storage unit 32 of the superimposition object recognition device 3, the superimposition image information storage unit 43 stores a superimposition image and a superimposition image ID that are associated with each other.

The trimming unit 44 generates face region image information indicating a face region image obtained by trimming the face region R1 in the captured image obtained by the imaging device 1 imaging the user in the preparation stage. Specifically, the trimming unit 44 may acquire face region information indicating the face region R1 in the captured image, from the region information storage unit 42. In the example illustrated in FIG. 4, the trimming unit 44 acquires the start point coordinates corresponding to the region ID “1” stored in the region information storage unit 42, and the face region information indicated by the X size and the Y size. The trimming unit 44 then extracts the face region R1 indicated by the face region information in the captured image, and generates face region image information indicating the image of the face region R1.

The trimming unit 44 also generates superimposition object region image information indicating a superimposition object region image obtained by trimming the superimposition object region R2 in the captured image obtained by the imaging device 1 imaging the superimposition object in the preparation stage. Specifically, the trimming unit 44 may acquire superimposition object region information indicating the superimposition object region R2 in the captured image, from the region information storage unit 42. In the example illustrated in FIG. 4, the trimming unit 44 acquires the start point coordinates corresponding to the region ID “2” stored in the region information storage unit 42, and the superimposition object region information indicated by the X size and the Y size. The trimming unit 44 then extracts the superimposition object region R2 indicated by the superimposition object region information in the captured image, and generates superimposition object region image information indicating the image of the superimposition object region.

The trimming unit 44 controls the communication unit 41 to transmit the face region image information to the face recognition device 2. The trimming unit 44 also controls the communication unit 41 to transmit the superimposition object region image information to the superimposition object recognition device 3.

The scenario control unit 45 extracts superimposition image information that is associated with the superimposition image ID recognized by the superimposition object recognition device 3 and is stored in the superimposition image information storage unit 43. The scenario control unit 45 also extracts combining region information indicating the combining region R3 corresponding to the region ID “3” stored in the region information storage unit 42. In the example illustrated in FIG. 5, the combining region information includes start point coordinates (X3, Y3), an X size “LX3”, and a Y size “LY3”.

The scenario control unit 45 then controls the communication unit 41 to transmit the face image information, the superimposition image information, the combining region information, and the captured image information generated by the imaging device 1 in the service providing stage, to the combining device 5.

### <Configuration of the Combining Device>

As illustrated in FIG. 1, the combining device 5 includes a communication unit 51, a face image detection unit 52, and a superimposition unit 53. The communication unit 51 is formed with a communication interface. The face image detection unit 52 and the superimposition unit 53 constitute a control unit.

The communication unit 51 receives, from the control device 4, the face image information, the superimposition image information, the combining region information, and the captured image information generated by the imaging device 1 in the service providing stage. The communication unit 51 also transmits combined image information to the display device 6, and the combined image information will be described later in detail.

The face image detection unit 52 detects the face image of the user, on the basis of the face image information from a combining region image that is an image of the combining region R3, which is larger than the face region R1 and the superimposition object region R2 in the captured image obtained by the imaging device 1 imaging the user in the service providing stage.

The superimposition unit 53 generates combined image information indicating a combined image obtained by superimposing the superimposition image on the face image. Specifically, the superimposition unit 53 superimposes the superimposition image indicated by the superimposition image information on the face image detected by the face image detection unit 52 in the captured image indicated by the captured image information. The superimposition unit 53 then generates combined image information indicating the combined image obtained by superimposing the superimposition image on the face image.

The superimposition unit 53 may also extract a feature parameter from the face image detected from the combining region image. The feature parameter is a parameter indicating a feature of the face image, and may be a parameter indicating the direction in which the face faces, the facial expression, or the like, for example. In such a configuration, the superimposition unit 53 may generate combined image information indicating a combined image in which the superimposition image is superimposed, in accordance with the feature parameter. For example, in a case where the feature parameter indicates that the left side of the face is shown to the imaging surface of the imaging device 1, the superimposition unit 53 may superimpose a superimposition image corresponding to the left side of the face. Further, in a configuration in which a captured image is a moving image, the superimposition unit 53 may change the superimposition image to be superimposed on the face image, in accordance with the change in the feature parameter of the face image in each image in a plurality of still images constituting the moving image.

The superimposition unit 53 also controls the communication unit 51 to transmit the combined image information to the display device 6.

### <Configuration of the Display Device>

The display device 6 is formed with a device that includes a display interface, a communication interface, and the like. The display interface may be formed with an organic electro luminescence (EL), a liquid crystal panel, or the like.

The display device 6 receives the combined image information transmitted from the combining device 5. The display device 6 then displays the combined image indicated by the combined image information.

### <Operation of the Image Superimposition System>

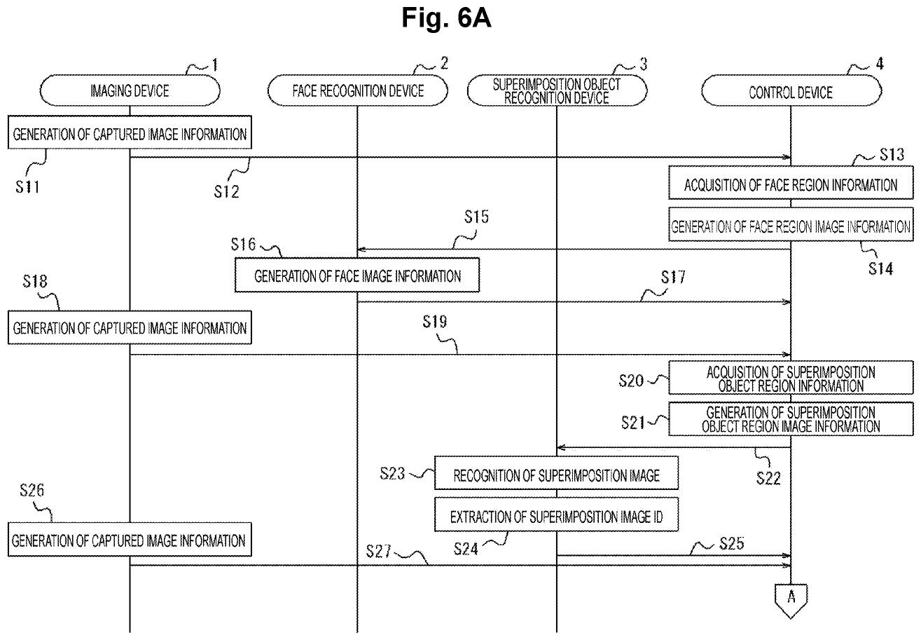

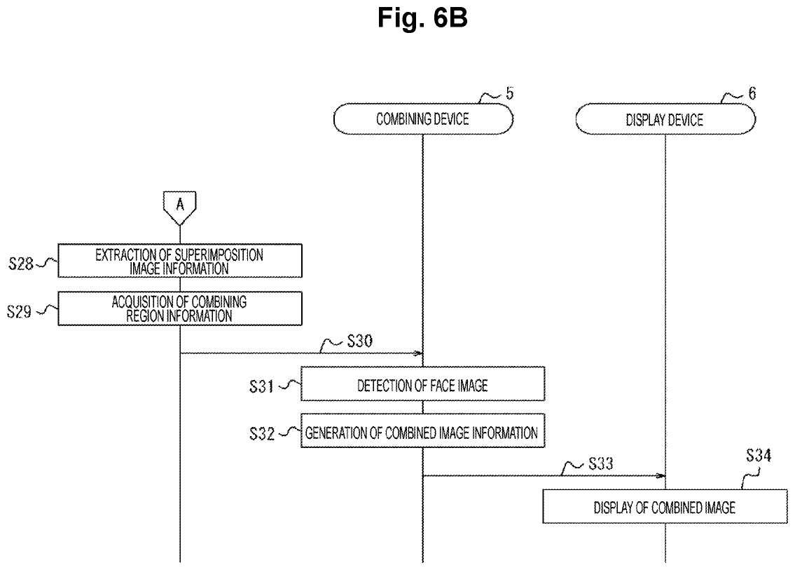

Referring now to FIGS. 6A and 6B, an operation to be performed by the image superimposition system 100 according to the first embodiment is described. FIGS. 6A and 6B are sequence diagrams illustrating an example operation to be performed by the image superimposition system 100 according to this embodiment. The operation in the image superimposition system 100 described below with reference to FIGS. 6A and 6B corresponds to an example of an image superimposition method implemented by the image superimposition system 100 according to the first embodiment.

As illustrated in FIG. 6A, the image superimposition system 100 first performs a preparation process in steps S11 to S19, which is the preparation stage.

In step S11, the imaging device 1 generates captured image information indicating a captured image obtained by imaging the user.

In step S12, the imaging device 1 transmits the captured image information to the control device 4.

In step S13, the trimming unit 44 of the control device 4 acquires face region information indicating the face region R1 in the captured image, from the region information storage unit 42.

In step S14, using the captured image information transmitted in step S12, the trimming unit 44 of the control device 4 generates face region image information indicating the face region image obtained by trimming the face region R1 in the captured image obtained by the imaging device 1 imaging the user.

In step S15, the trimming unit 44 of the control device 4 controls the communication unit 41 to transmit the face region image information to the face recognition device 2. Accordingly, the communication unit 41 transmits the face region image information to the face recognition device 2.

In step S16, the face recognition device 2 recognizes the face image included in the image indicated by the face region image information, and generates face image information indicating the face image.

In step S17, the face recognition device 2 transmits the face image information to the control device 4.

In step S18, the imaging device 1 generates captured image information indicating a captured image obtained by imaging the superimposition object. At this point of time, the imaging device 1 may generate captured image information indicating a captured image obtained by capturing the superimposition object together with the user, with the superimposition object being located between the face of the user and the imaging device 1.

In step S19, the imaging device 1 transmits the captured image information to the control device 4.

In step S20, the trimming unit 44 of the control device 4 acquires, from the region information storage unit 42, superimposition object region information indicating the superimposition object region R2 in the captured image.

In step S21, using the captured image information transmitted in step S19, the trimming unit 44 of the control device 4 generates superimposition object region image information indicating the superimposition object region image obtained by trimming the superimposition object region R2 in the captured image obtained by the imaging device 1 imaging the superimposition object.

In step S22, the trimming unit 44 of the control device 4 controls the communication unit 41 to transmit the superimposition object region image information to the superimposition object recognition device 3. Accordingly, the communication unit 41 transmits the superimposition object region image information to the superimposition object recognition device 3.

In step S23, the recognition unit 33 of the superimposition object recognition device 3 recognizes the superimposition image corresponding to the superimposition object region image indicated by the superimposition object region image information. The recognition unit 33 may recognize the superimposition image corresponding to the superimposition object region image indicated by the superimposition object region image information, from among the superimposition images stored in the superimposition image information storage unit 32.

In step S24, the recognition unit 33 of the superimposition object recognition device 3 extracts the superimposition image ID that is associated with the recognized superimposition image and is stored in the superimposition image information storage unit 32.

In step S25, the recognition unit 33 of the superimposition object recognition device 3 controls the communication unit 31 to transmit the superimposition image ID to the control device 4. Accordingly, the communication unit 31 transmits the superimposition image ID to the control device 4.

After the preparation stage in steps S11 to S25 as described above, the image superimposition system 100 performs a service providing process in steps S26 to S31, which is the service providing stage.

In step S26, the imaging device 1 generates captured image information indicating a captured image obtained by imaging the user.

In step S27, the imaging device 1 transmits the captured image information to the control device 4.

As illustrated in FIG. 6B, in step S28, the scenario control unit 45 of the control device 4 extracts the superimposition image information that is associated with the superimposition image ID recognized by the superimposition object recognition device 3 and is stored in the superimposition image information storage unit 43.

In step S29, the scenario control unit 45 of the control device 4 acquires, from the region information storage unit 42, combining region information indicating the combining region R3 in the captured image.

In step S30, the scenario control unit 45 of the control device 4 controls the communication unit 41 to transmit the face image information, the superimposition image information, the combining region information, and the captured image information generated by the imaging device 1 in the service providing stage, to the combining device 5. Accordingly, the communication unit 41 transmits the face image information, the superimposition image information, the combining region information, and the captured image information generated by the imaging device 1 in the service providing stage, to the combining device 5.

In step S31, using the captured image information, the face image detection unit 52 of the combining device 5 detects the face image of the user, on the basis of the face image information from a combining region image that is an image of the combining region R3, which is larger than the face region R1 in the captured image obtained by the imaging device 1 imaging the user in the service providing stage.

In step S32, the superimposition unit 53 of the combining device 5 generates combined image information indicating the image obtained by superimposing the superimposition image on the face image.

In step S33, the superimposition unit 53 of the combining device 5 controls the communication unit 51 to transmit the combined image information to the display device 6. Accordingly, the communication unit 51 transmits the combined image information to the display device 6.

In step S34, the display device 6 displays the combined image indicated by the combined image information.

As described above, according to the first embodiment, the image superimposition system 100 generates, in the preparation stage, face region image information indicating a face region image obtained by trimming the face region R1 in a captured image obtained by the imaging device 1 imaging the user, and generates, in the preparation stage, superimposition object region image information indicating a superimposition object region image obtained by trimming the superimposition object region R2 in a captured image obtained by the imaging device 1 imaging the superimposition object. The image superimposition system 100 then recognizes the user's face image included in the face region image, generates face image information indicating the face image, recognizes the superimposition image corresponding to the superimposition object region image, and extracts a superimposition image ID for identifying the superimposition image. Further, the image superimposition system 100 recognizes the face image of the user on the basis of the face image information from a combining region image that is an image of the combining region R3 larger than the face region R1 and the superimposition object region R2 in a captured image obtained by the imaging device 1 imaging the user in the service providing stage after the preparation stage, and generates combined image information indicating a combined image in which the superimposition image identified by the superimposition image ID is superimposed on the face image. Thus, the image superimposition system 100 can track the face image of the user over a wide range in a captured image and superimpose a superimposition image thereon, while improving the accuracy of recognition of the face image and the type of “kumadori” makeup. In particular, in a case where the superimposition object is “kumadori” makeup in Kabuki, in addition to the examples illustrated in FIGS. 2B, 3A, and 3B, there are a large number of types of “kumadori”, and the differences among them are subtle. In view of this, improvement of recognition accuracy is beneficial.

Note that, in the first embodiment described above, the image superimposition system 100 includes the imaging device 1, but is not limited to this configuration. For example, the image superimposition system 100 may not include the imaging device 1, and may acquire a captured image from an external imaging device.

Also, in the first embodiment described above, the communication unit 41 of the control device 4 transmits superimposition image information to the combining device 5, but the present invention is not limited to this configuration. For example, the communication unit 41 may transmit a superimposition image ID to the combining device 5, and the combining device 5 may extract the superimposition image corresponding to the superimposition image ID from a storage unit included in the combining device 5.

Further, in the first embodiment described above, the image superimposition system 100 includes the display device 6, but is not limited to this configuration. For example, the image superimposition system 100 may not include the display device 6, and may transmit a captured image to an external display device or may transmit a captured image to some other external device.

Also, in the first embodiment described above, the superimposition unit 53 of the combining device 5 extracts a feature parameter from a face image, but the present invention is not limited to this configuration. For example, the recognition unit 33 of the face recognition device 2 may recognize a face image, and extract a feature parameter from the face image. In such a configuration, the feature parameter is transmitted to the combining device 5.

Further, in the first embodiment described above, any two or more devices included in the image superimposition system 100 may be integrally formed. In such a configuration, exchange of information between functional units included in the two or more devices integrally formed may be performed without any communication unit.

### Second Embodiment

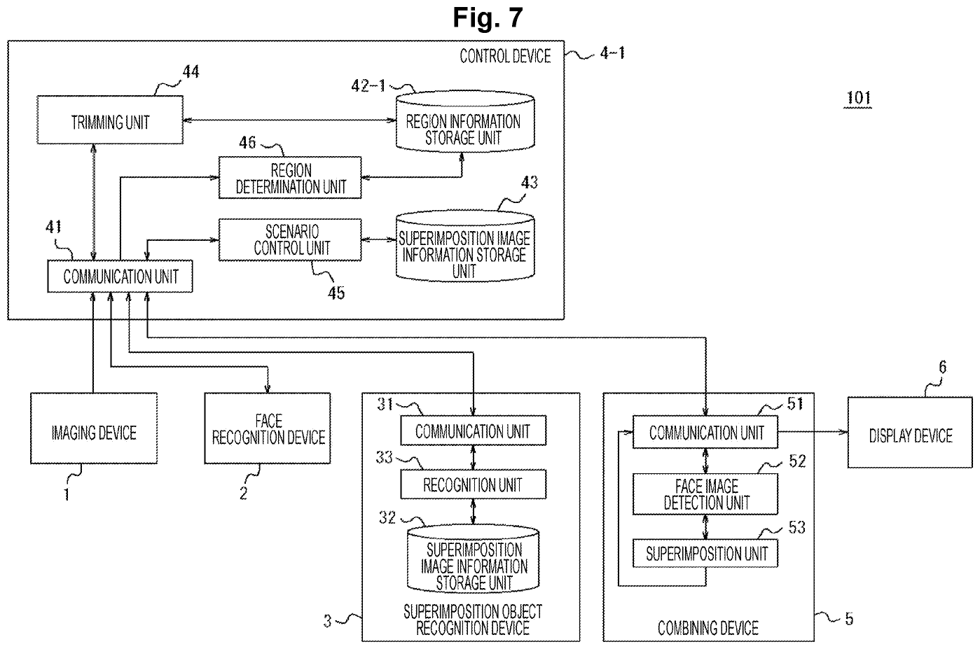

An overall configuration of a second embodiment is now described with reference to FIG. 7. FIG. 7 is a schematic diagram of an image superimposition system 101 according to the second embodiment. In the second embodiment, the same functional units as those of the first embodiment are denoted by the same reference numerals as those used in the first embodiment, and explanation of them is not made herein.

As illustrated in FIG. 7, an image superimposition system 101 according to the second embodiment includes an imaging device 1, a face recognition device 2, a superimposition object recognition device 3, a control device 4-1, a combining device 5, and a display device 6. The control device 4-1 communicates with the imaging device 1, the face recognition device 2, the superimposition object recognition device 3, and the combining device 5 via a communication network.

### <Configuration of the Control Device>

The control device 4-1 includes a communication unit 41, a region information storage unit 42-1, a superimposition image information storage unit 43, a trimming unit 44, a scenario control unit 45, and a region determination unit 46. The region information storage unit 42-1 is formed with a memory. The region determination unit 46 forms a control unit.

The region determination unit 46 determines a superimposition object region R2 in a captured image, on the basis of the position of the face image recognized by the face recognition device 2 in the captured image. For example, the region determination unit 46 may determine the superimposition object region R2 to be a region within a first predetermined length from the center of the face image recognized by the face recognition device 2. For example, the region determination unit 46 may determine the superimposition object region R2 to be a region formed by adding a region within a second predetermined length from the periphery of the face image to the region of the face image recognized by the face recognition device 2. Also, the region determination unit 46 may determine the superimposition object region R2 to be a region in a rectangle of a predetermined size whose center of gravity is located at the center of the face image recognized by the face recognition device 2, for example.

Like the region information storage unit 42 of the first embodiment, the region information storage unit 42-1 stores region IDs for identifying the regions in a captured image, and information indicating the ranges of the regions, the region IDs being associated with the information. The regions include a face region R1, the superimposition object region R2, and a combining region R3, as in the first embodiment. The face region R1 and the combining region R3 in the second embodiment are predetermined regions, like the face region R1 and the combining region R3 in the first embodiment, respectively. Unlike the superimposition object region R2 in the first embodiment, the superimposition object region R2 in the second embodiment is not a predetermined region, but the superimposition object region R2 is determined by the region determination unit 46. Note that the determined superimposition object region R2 may be indicated by start point coordinates, an X size, and a Y size, as in the first embodiment.

In the second embodiment, the trimming unit 44 generates superimposition object region image information indicating a superimposition object region image obtained by trimming the superimposition object region R2 in a captured image obtained by the imaging device imaging the superimposition object in the preparation stage, as described in the first embodiment. Since the region determination unit 46 and the region information storage unit 42-1 are designed as described above in the second embodiment, the trimming unit 44 generates superimposition object region image information indicating a superimposition object region image obtained by trimming the superimposition object region R2 determined by the region determination unit 46 in a captured image.

### <Operation of the Image Superimposition System>

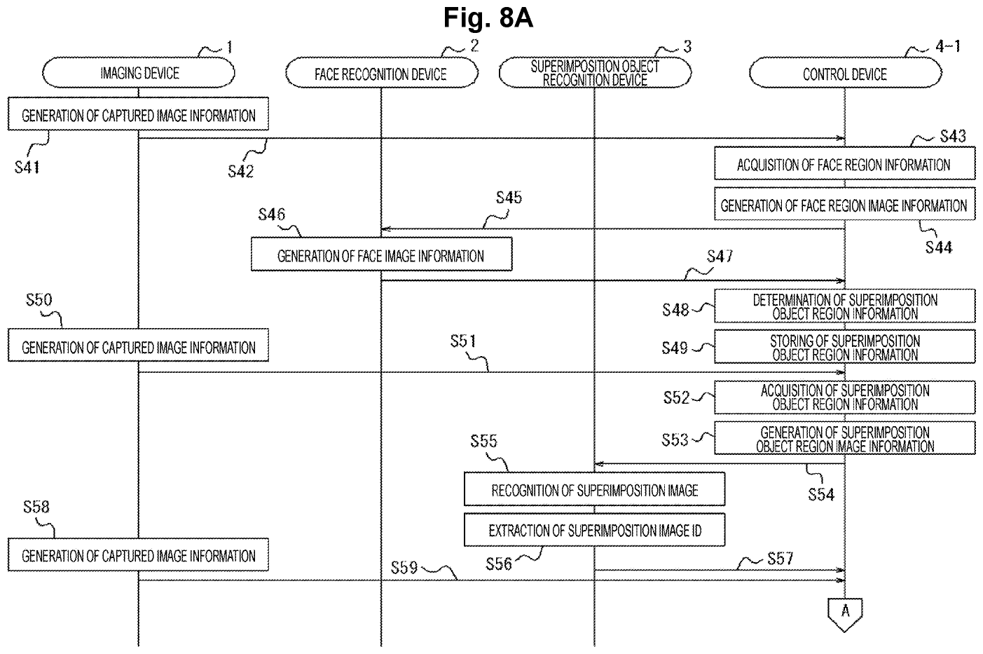

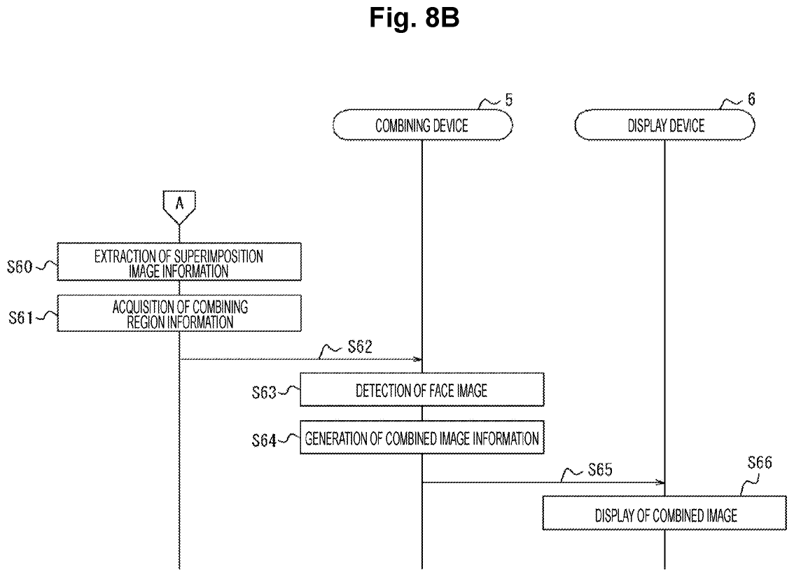

Referring now to FIGS. 8A and 8B, an operation to be performed by the image superimposition system 101 according to the second embodiment is described. FIGS. 8A and 8B are flowcharts showing an example operation to be performed by the image superimposition system 101 according to this embodiment. The operation in the image superimposition system 101 described below with reference to FIGS. 8A and 8B corresponds to an example of an image superimposition method implemented by the image superimposition system 101 according to the second embodiment.

As illustrated in FIG. 8A, the image superimposition system 101 performs a process from step S41 to step S47. The process from step S41 to step S47 is the same as the process from step S11 to step S17 in the first embodiment.

In step S48, the region determination unit 46 determines the superimposition object region R2, on the basis of the face image.

In step S49, the region information storage unit 42-1 stores the superimposition object region R2 determined in step S48. Specifically, the region information storage unit 42-1 stores the start point coordinates, the X size, and the Y size indicating the superimposition object region R2 determined in step S48, with the superimposition object ID for identifying the superimposition object region R2 being associated with the start point coordinates, the X size, and the Y size.

As illustrated in FIGS. 8A and 8B, the image superimposition system 101 then performs a process from step S50 to step S66. The process from step S50 to step S66 is the same as the process from step S18 to step S34 in the first embodiment. Thus, in step S52, the trimming unit 44 generates superimposition object region image information indicating a superimposition object region image obtained by trimming the superimposition object region R2 determined by the region determination unit 46 in the captured image.

As described above, according to the second embodiment, the image superimposition system 101 determines the superimposition object region R2 on the basis of the face image included in a face region image, and generates the superimposition object region image information indicating the superimposition object region image obtained by trimming the superimposition object region R2 in the captured image. Accordingly, the image superimposition system 101 can determine the superimposition object region R2 to be a region having a high possibility that an image of the superimposition object is located in the captured image. Thus, the image superimposition system 101 can appropriately recognize the superimposition image, and can also superimpose the appropriate superimposition image on the face image. For example, in a case where the user is an adult, a child, a wheelchair user, or the like, the face region R1 needs to be set in a wide region. However, the image superimposition system 101 can limit the position and the size of the superimposition object region R2 with a result of recognition of the face image. Thus, the superimposition image can be appropriately recognized and be appropriately superimposed on the face image.

### <Program>

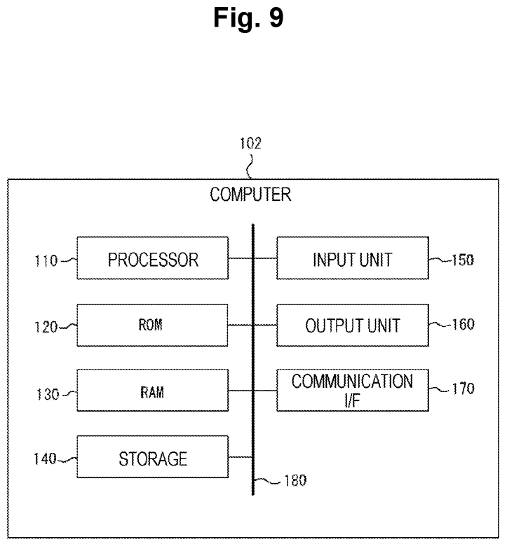

The control device 4 or 4-1 and the combining device 5 described above can be formed with a computer 102. A program for causing the computer 102 to function as the control device 4 or 4-1 and the combining device 5 may also be provided. Further, the program may be stored in a storage medium or may be provided through a network. FIG. 9 is a block diagram illustrating a schematic configuration of the computer 102 that functions as the control device 4 or 4-1 and the combining device 5. Here, the computer 102 may be a general-purpose computer, a dedicated computer, a workstation, a personal computer (PC), an electronic notepad, or the like. A program instruction may be a program code, a code segment, or the like for executing a required task.

As illustrated in FIG. 9, the computer 102 includes a processor 110, a read only memory (ROM) 120, a random access memory (RAM) 130, a storage 140, an input unit 150, a display unit 160, and a communication interface (I/F) 170. The respective components are connected via a bus 180 so as to be able to communicate with one another. Specifically, the processor 110 is a central processing unit (CPU), a micro processing unit (MPU), a graphics processing unit (GPU), a digital signal processor (DSP), a system on a chip (SoC), or the like, and may be formed with a plurality of processors of the same type or different types.

The processor 110 controls the respective components, and performs various kinds of arithmetic processing. That is, the processor 110 reads a program from the ROM 120 or the storage 140, and executes the program by using the RAM 130 as a work area. The processor 110 controls the respective components described above and performs various kinds of arithmetic processing, in accordance with the program stored in the ROM 120 or the storage 140. In this embodiment, a program according to the present disclosure is stored in the ROM 120 or the storage 140.

The program may be stored in a storage medium that can be read by the computer 102. With such a storage medium, the program can be installed into the computer 102. Here, the storage medium in which the program is stored may be a non-transitory storage medium. The non-transitory storage medium is not limited to any particular storage medium, but may be a CD-ROM, a DVD-ROM, a universal serial bus (USB) memory, or the like, for example. Alternatively, the program may be downloaded from an external device via a network.

The ROM 120 stores various kinds of programs and various kinds of data. Serving as a work area, the RAM 130 temporarily stores programs or data. The storage 140 is formed with a hard disk drive (HDD) or a solid state drive (SSD), and stores various kinds of programs including an operating system and various kinds of data.

The input unit 150 includes one or more input interfaces that receive a user's input operation and acquire information based on the user's operation. For example, the input unit 150 is a pointing device, a keyboard, a mouse, or the like, but is not limited to these devices.

The display unit 160 includes one or more output interfaces that output information. For example, the display unit 160 is a display that outputs information as a video, or a speaker that outputs information as sound, but is not limited to these devices. Note that, in a case where the display unit 160 is a touch-panel display, the display unit 160 also functions as the input unit 150.

The communication interface (I/F) 170 is an interface for communicating with an external device.

Regarding the above embodiments, the following supplementary notes are further disclosed herein.

### (Supplementary Note 1)

An image superimposition system including
a control unit,
in which the control unit
generates face region image information indicating a face region image obtained by trimming a face region in a captured image obtained by an imaging device imaging a user in a first stage,
generates superimposition object region image information indicating a superimposition object region image obtained by trimming a superimposition object region in a captured image obtained by the imaging device imaging a superimposition object in the first stage,
recognizes a face image of the user included in the face region image, and generates face image information indicating the face image,
recognizes a superimposition image corresponding to the superimposition object region image,
recognizes a face image of the user on the basis of the face image information from a combining region image that is an image of a combining region larger than the face region and the superimposition object region in a captured image obtained by the imaging device imaging the user in a second stage after the first stage, and generates combined image information indicating a combined image obtained by superimposing the superimposition image identified by a superimposition image identifier on the face image.

### (Supplementary Note 2)

The image superimposition system of Supplementary Note 1, in which the control unit determines the superimposition object region on the basis of the face image, and generates the superimposition object region image information indicating the superimposition object region image obtained by trimming the superimposition object region in the captured image.

### (Supplementary Note 3)

An image superimposition method including:
a step of generating face region image information indicating a face region image obtained by trimming a face region in a captured image obtained by an imaging device imaging a user in a first stage;
a step of generating superimposition object region image information indicating a superimposition object region image obtained by trimming a superimposition object region in a captured image obtained by the imaging device imaging a superimposition object in the first stage;
a step of recognizing a face image of the user included in the face region image, and generating face image information indicating the face image;
a step of recognizing a superimposition image corresponding to the superimposition object region image, and extracting a superimposition image identifier for identifying the superimposition image;
a step of recognizing a face image of the user on the basis of the face image information from a combining region image that is an image of a combining region larger than the face region and the superimposition object region in a captured image obtained by the imaging device imaging the user in a second stage after the first stage; and
a step of generating combined image information indicating a combined image obtained by superimposing the superimposition image on the face image.

### (Supplementary Note 4)

The image superimposition method of Supplementary Note 3, further including
a step of determining the superimposition object region, on the basis of the face image included in the face region image,
in which the step of generating the superimposition object region image information includes a step of generating the superimposition object region image information indicating the superimposition object region image obtained by trimming the superimposition object region in the captured image.

All literatures, patent applications, and technical standards mentioned in this specification are incorporated herein by reference to the same extent as in a case where the respective literatures, patent applications, and technical standards are specifically and individually described to be incorporated by reference.

Although the above embodiments have been described as typical examples, it is apparent to those skilled in the art that many modifications and substitutions can be made within the spirit and scope of the present disclosure. Accordingly, it should not be understood that the present invention is limited by the above embodiments, and various modifications or changes can be made within the scope of the claims. For example, a plurality of configuration blocks illustrated in the configuration diagrams of the embodiments can be combined into one, or one configuration block can be divided.

### REFERENCE SIGNS LIST

1 imaging device
2 face recognition device
3 superimposition object recognition device
4, 4-1 control device
5 combining device
6 display device
31 communication unit
32 superimposition image information storage unit
33 recognition unit
41 communication unit
42, 42-1 region information storage unit
43 superimposition image information storage unit
44 trimming unit
45 scenario control unit
46 region determination unit
51 communication unit
52 face image detection unit
53 superimposition unit
100, 101 image superimposition system
102 computer
110 processor
120 ROM
130 RAM
140 storage
150 input unit
160 output unit
170 communication interface
180 bus

1. An image superimposition system comprising a processor configured to execute operations comprising:
generating face region image information indicating a face region image obtained by trimming a face region in a first captured image imaging a user in a first stage;
generating superimposition object region image information indicating a superimposition object region image obtained by trimming a superimposition object region in a second captured image imaging a superimposition object in the first stage;
recognizing a face image of the user included in the face region image;
generating face image information indicating the face image;
recognizing a superimposition image corresponding to the superimposition object region image; and
detecting a face image of the user on a basis of the face image information from a combining region image that is an image of a combining region larger than the face region and the superimposition object region in a third captured image imaging the user in a second stage after the first stage; and
generating combined image information indicating a combined image formed by superimposing the superimposition image on the face image.

2. The image superimposition system according to claim 1, wherein the generating superimposition object region image information further comprises:
determining the superimposition object region on a basis of the face image, and
generating the superimposition object region image information indicating the superimposition object region image obtained by trimming the superimposition object region in the captured image.

3. An image superimposition method comprising:
generating face region image information indicating a face region image obtained by trimming a face region in a captured image obtained by an imaging device imaging a user in a first stage;
generating superimposition object region image information indicating a superimposition object region image obtained by trimming a superimposition object region in a captured image obtained by the imaging device imaging a superimposition object in the first stage;
recognizing a face image of the user included in the face region image, and generating face image information indicating the face image;
recognizing a superimposition image corresponding to the superimposition object region image;
detecting a face image of the user on a basis of the face image information from a combining region image that is an image of a combining region larger than the face region and the superimposition object region in a captured image obtained by the imaging device imaging the user in a second stage after the first stage; and
generating combined image information indicating a combined image formed by superimposing the superimposition image on the face image.

4. The image superimposition method according to claim 3, further comprising
determining the superimposition object region, on a basis of the face image included in the face region image,
wherein the generating the superimposition object region image information further comprises generating the superimposition object region image information indicating the superimposition object region image obtained by trimming the superimposition object region in the captured image.

5. The image superimposition system according to claim 1, wherein the superimposition object includes a mask of a kumadori makeup for exaggerating facial expression in Kabuki.

6. The image superimposition method according to claim 3, wherein the superimposition object includes a mask of a kumadori makeup for exaggerating facial expression in Kabuki.

7. A computer-readable non-transitory recording medium storing a computer-executable program instructions that when executed by a processor cause a computer to execute operations comprising:
generating face region image information indicating a face region image obtained by trimming a face region in a first captured image imaging a user in a first stage;
generating superimposition object region image information indicating a superimposition object region image obtained by trimming a superimposition object region in a second captured image imaging a superimposition object in the first stage;
recognizing a face image of the user included in the face region image;
generating face image information indicating the face image;
recognizing a superimposition image corresponding to the superimposition object region image; and
detecting a face image of the user on a basis of the face image information from a combining region image that is an image of a combining region larger than the face region and the superimposition object region in a third captured image imaging the user in a second stage after the first stage; and
generating combined image information indicating a combined image formed by superimposing the superimposition image on the face image.

8. The computer-readable non-transitory recording medium according to claim 7,
wherein the generating superimposition object region image information further comprises:
determining the superimposition object region on a basis of the face image, and
generating the superimposition object region image information indicating the superimposition object region image obtained by trimming the superimposition object region in the captured image.

9. The computer-readable non-transitory recording medium according to claim 7,
wherein the superimposition object includes a mask of a kumadori makeup for exaggerating facial expression in Kabuki.
